(19) United States
(12) Patent Application Publication
(10) Pub. No.: US 2019/0134791 A1
(43) Pub. Date: May 9, 2019

(54) Powered Wrench Assembly

(71) Applicant: John LaCoste, Canyon Lake, CA (US)

(72) Inventor: John LaCoste, Canyon Lake, CA (US)

(21) Appl. No.: 15/806,977

(22) Filed: Nov. 8, 2017

(51) Int. Cl. B25B 21/00; B25B 23/12; B25B 23/147; B25B 13/08

(52) U.S. Cl. CPC B25B 21/00; B25B 13/08; B25B 23/147; B25B 23/12

(57) ABSTRACT

A powered wrench assembly for tightening and loosening a fastener includes a wrench that is selectively manipulated. A rotating unit is movably coupled to the wrench and the rotating unit frictionally engages the fastener. The rotating unit is selectively turned on having the rotating unit rotating in the wrench. In this way the rotating unit selectively tightens and loosens the fastener.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed under 37 CFR 1.97 and 1.98

The disclosure and prior art relates to wrench devices and more particularly pertains to a new wrench device for selectively tightening and loosening a fastener.

### BRIEF SUMMARY OF THE INVENTION

An embodiment of the disclosure meets the needs presented above by generally comprising a wrench that is selectively manipulated. A rotating unit is movably coupled to the wrench and the rotating unit frictionally engages the fastener. The rotating unit is selectively turned on having the rotating unit rotating in the wrench. In this way the rotating unit selectively tightens and loosens the fastener.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a powered wrench assembly according to an embodiment of the disclosure.

FIG. 2 is a cross sectional view taken along line 2-2 of FIG. 1 of an embodiment of the disclosure.

FIG. 3 is a cross sectional view taken along line 3-3 of FIG. 2 of an embodiment of the disclosure.

FIG. 4 is a top phantom view of a case and a set of wrenches of an embodiment of the disclosure.

FIG. 5 is a schematic view of an embodiment of the disclosure.

### DETAILED DESCRIPTION OF THE INVENTION

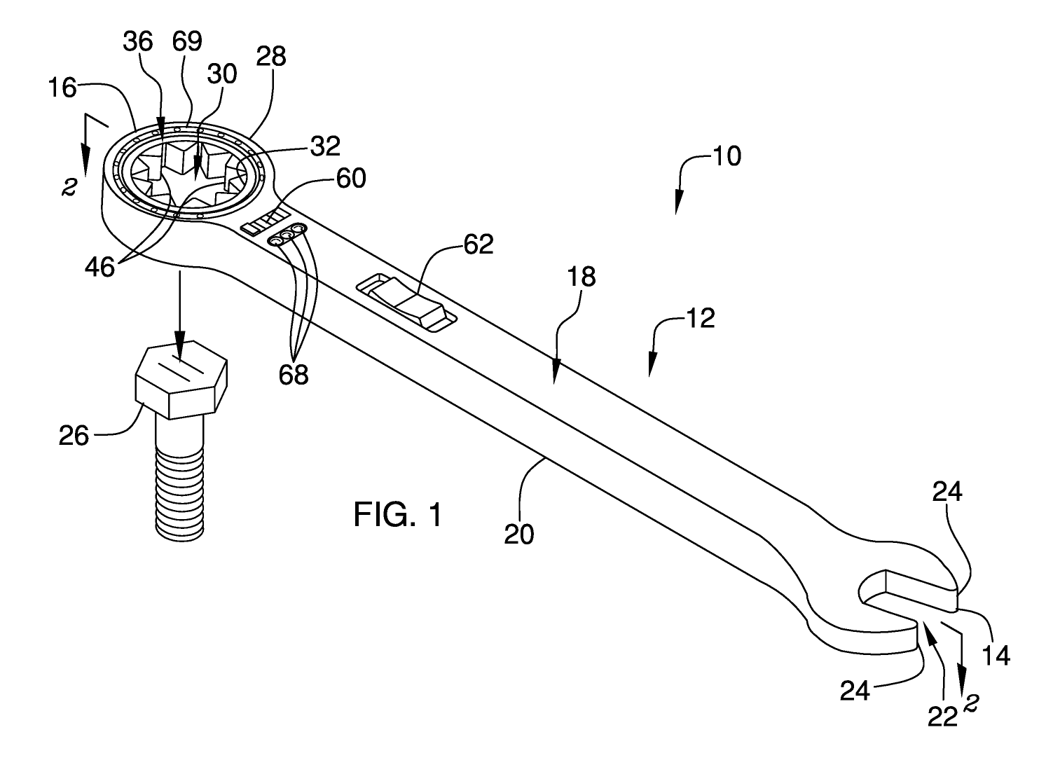

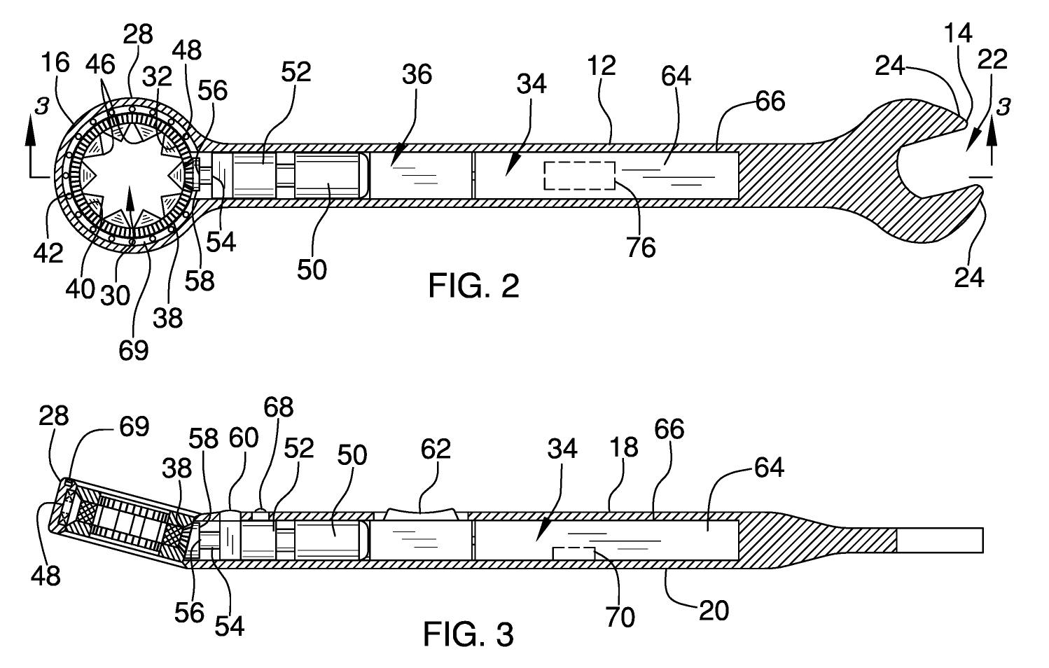

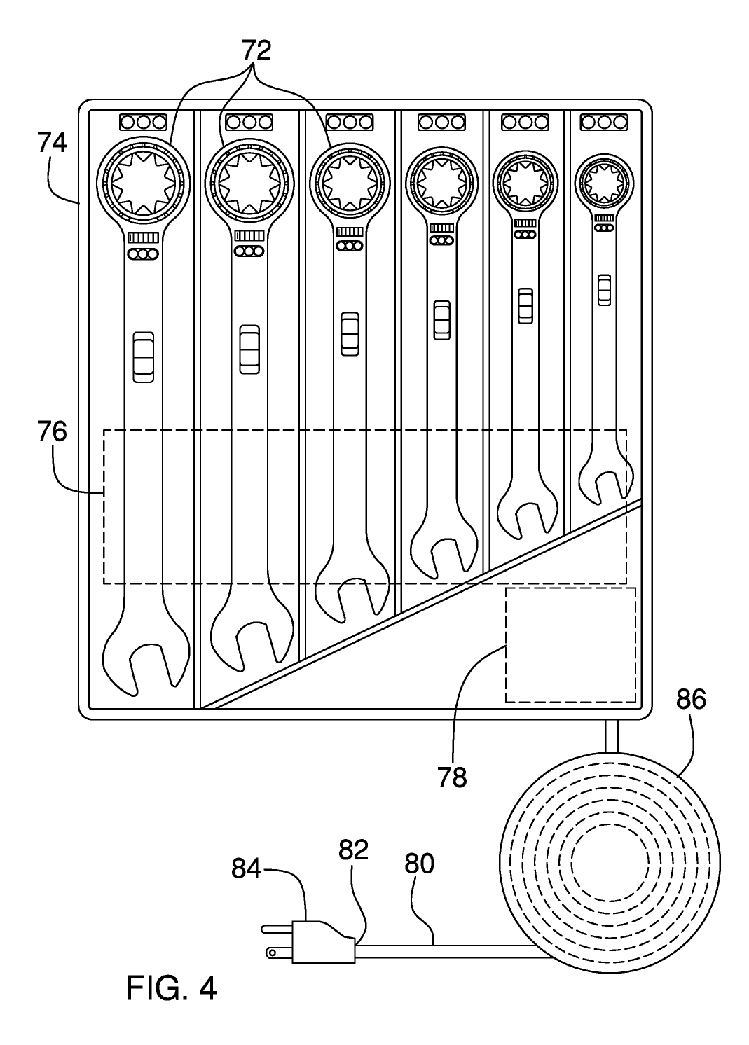

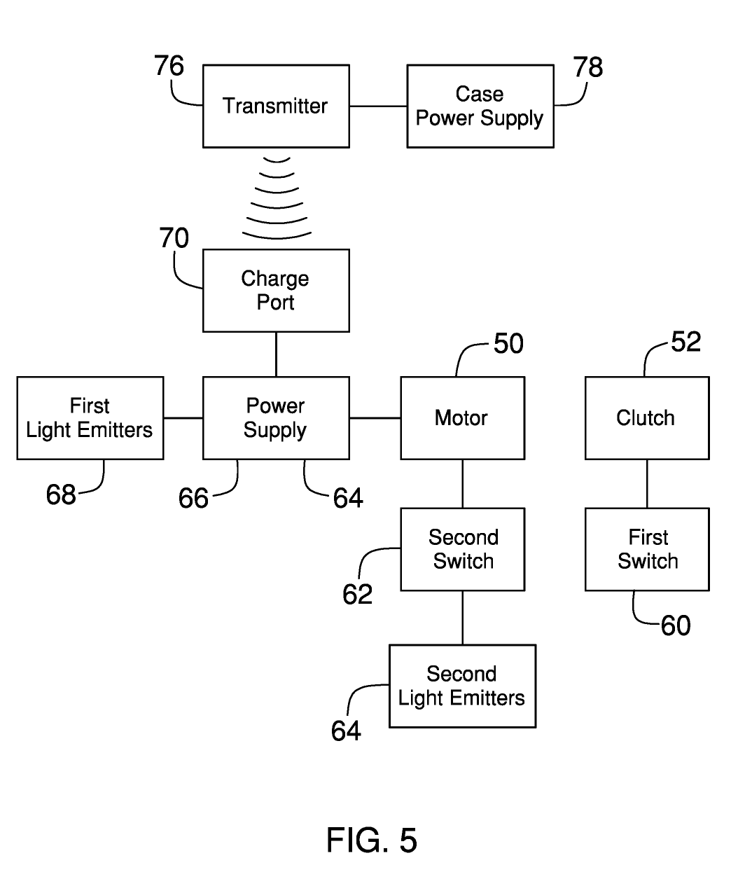

With reference now to the drawings, and in particular to FIGS. 1 through 4 thereof, a new wrench device embodying the principles and concepts of an embodiment of the disclosure and generally designated by the reference numeral 10 will be described.

As best illustrated in FIGS. 1 through 4, the powered wrench assembly 10 generally comprises a wrench 12 that may be manipulated. The wrench 12 has a first end 14, a second end 16, a top surface 18 and a bottom surface 20. The first end 14 has a slot 22 extending toward the second end 16 to define a pair of fingers 24 that are spaced apart from each other. Each of the fingers 24 selectively grips a fastener 26 thereby facilitating the fastener 26 to be selectively tightened and loosened. The fastener 26 may be a bolt or a nut and the slot 22 may have a width that corresponds to standard and metric nut and bolt sizes.

The second end 16 is rounded to define a lobe 28 and the wrench 12 has an aperture 30 extending through the top surface 18 and the bottom surface 20. The aperture 30 is centrally positioned on the lobe 28 and the aperture 30 is concentric with the lobe 28. The aperture 30 may have a diameter that corresponds to standard metric nut and bolt sizes. The fastener 26 is selectively positioned within the aperture 30 and the aperture 30 has a bounding surface 32. The wrench 12 is substantially hollow between the first end 14 and the second end 16 to define a space 34 within the wrench 12. Moreover, the lobe 28 may be positioned at an angle with respect to a longitudinal axis extending through the first end 14 and the second end 16 of the wrench 12.

A rotating unit 36 is movably coupled to the wrench 12 and the rotating unit 36 frictionally engages the fastener 26. The rotating unit 36 is selectively turned on having the rotating unit 36 rotating in the wrench 12. In this way the rotating unit 36 selectively tightens and loosens the fastener 26. The rotating unit 36 comprises a ring gear 38 that is rotatably positioned within the wrench 12. The ring gear 38 has an inwardly facing surface 40, an outwardly facing surface 42 and a top surface 44. Moreover, the ring is positioned in the aperture 30 having the inwardly facing surface 40 being coextensive with the bounding surface 32.

The ring gear 38 has a plurality of teeth 46 and each of the teeth 46 extends inwardly from the inwardly facing surface 40 toward a center of the aperture 30. The teeth 46 are spaced apart from each other and are distributed around the ring gear 38. Each of the teeth 46 frictionally engage an associated one of a plurality of intersecting sides of the fastener 26 when the second end 16 of the wrench 12 is positioned around the fastener 26. Moreover, each of the teeth 46 is comprised of a magnetic material to magnetically engage the fastener 26.

A bearing 48 is positioned within the second end 16 of the wrench 12 and the outwardly facing surface 42 of the ring gear 38 engages the bearing 48. In this way the bearing 48 reduces friction between the ring gear 38 and the bearing 48. The bearing 48 may be a ball bearing, a pin bearing or any other type of friction reducing bearing. A motor 50 is positioned within the space 34 in the wrench 12 and the motor 50 selectively rotates in a first direction and a second direction. The motor 50 may be an electric motor 50 or the like.

A clutch 52 is positioned within the space 34 in the wrench 12 and the clutch 52 is positioned between the motor 50 and the ring gear 38. Moreover, the clutch 52 is mechanically coupled to the motor 50 such that the motor 50 rotates the clutch 52 when the motor 50 is turned on. The clutch 52 may be an electrically controlled, mechanical clutch of any conventional design. A drive shaft 54 is rotatably coupled to the clutch 52 such that the clutch 52 rotates the drive shaft 54 when the motor 50 is turned on. The drive shaft 54 has a distal end 56 with respect to the clutch 52.

A drive gear 58 is coupled to the distal end 56 of the drive shaft 54 such that the drive shaft 54 rotates the drive gear 58 when the motor 50 is turned on. The drive gear 58 engages the top surface 18 of the ring gear 38 such that the drive gear 58 rotates the ring gear 38 when the motor 50 is turned on. The drive gear 58 may be a beveled gear or the like such that the drive gear 58 transfers rotational torque at a perpendicular angle to the drive shaft 54.

A first switch 60 is slidably coupled to the wrench 12 and the first switch 60 is selectively manipulated. The first switch 60 is coupled to the clutch 52 such that the first switch 60 actuates the clutch 52 between a minimum torque and a maximum torque. Thus, the clutch 52 imparts a selected amount of rotational torque to the fastener 26. The minimum torque may be a rotational torque ranging between approximately 10.0 inch lbs and 15.0 inch lbs. The maximum torque may be a rotational torque ranging between approximately 40.0 inch lbs and 50.0 inch lbs. The first switch 60 may be recessed into the top surface 18 of the wrench 12.

A second switch 62 is slidably coupled to the wrench 12 and the second switch 62 is selectively manipulated. The second switch 62 is electrically coupled to the motor 50 and the second switch 62 is selectively urged into a first position to turn the motor 50 off. Additionally, the second switch 62 is selectively urged into a second position to turn the motor 50 on to rotate in the first direction. The first direction is counterclockwise to loosen the fastener 26 when the fastener 26 is positioned in the aperture 30.

The second switch 62 is selectively urged into a third position to turn the motor 50 on to rotate in the second direction. The second direction is clockwise to tighten the fastener 26 when the fastener 26 is positioned in the aperture 30. The second switch 62 may be recessed into the top surface 18 of the wrench 12. A rubber gasket may be provided and the rubber gasket may be positioned between the second switch 62 and the wrench 12 thereby forming a fluid impermeable seal between the second switch 62 and the wrench 12.

A power supply 64 is positioned within the space 34 in the wrench 12 and the power supply 64 is electrically coupled to the motor 50. The power supply 64 comprises at least one battery 66 that is positioned within the space 34. The at least one battery 66 is electrically coupled to the motor 50 and the at least one battery 66 may comprise a rechargeable, lithium ion battery 66 or the like.

A plurality of first light emitters 68 is provided and each of the first light emitters 68 is coupled to the top surface 18 of the wrench 12. Each of the first light emitters 68 emits light outwardly therefrom and each of the first light emitters 68 may comprise an LED or the like. Each of the first light emitters 68 is electrically coupled to the at least one battery 66 such that each of the first light emitters 68 is sequentially turned on to indicate a charge level of the at least one battery 66.

A plurality of second light emitters 69 is provided and each of the second light emitters 69 is coupled to the bottom surface 20 of the wrench 12. The second light emitters 69 are spaced apart from each other and are distributed around the ring gear 38. Each of the second light emitters 69 is electrically coupled to the second switch 62. Moreover, each of the second light emitters 69 is turned on when the second switch 62 is positioned in either of the second or third positions. Each of the second light emitters 69 may comprise an LED or the like.

A charge port 70 is coupled to the wrench 12 and the charge port 70 selectively placed in electrical communication with a power source. The charge port 70 is electrically coupled to the at least one battery 66 to charge the at least one battery 66. Moreover, the charge port 70 may be a wireless charge port 70, such as an induction charge port or the like. Additionally, a set of the wrenches 72 may be provided and each of the wrenches 72 may have a unique size with respect to each other. Each of the sets of wrenches 72 includes the rotating unit 36. The open end wrench and the closed end

A case 74 is provided and each of the sets of wrenches 72 is selectively placed in the case 74. A transmitter 76 is coupled to the case 74 and the transmitter 76 is in wireless electrical communication with the charge port 70 corresponding to each of the sets of wrenches 72 when each of the sets of wrenches 72 is positioned in the case 74. The transmitter 76 may comprise a radio frequency transmitter 76 or the like that is capable of wirelessly transmitting an electrical charge. In this way the transmitter 76 wireles sly charges the at least one battery 66 corresponding to each of the sets of wrenches 72. Additionally, the transmitter 76 may be an induction charger or the like.

A case power supply 78 is coupled to the case 74 and the case power supply 78 is electrically coupled to the transmitter 76. A power cord 80 is coupled to and extends outwardly from the case 74 and the power cord 80 is electrically coupled to the case power supply 78. The power cord 80 has a distal end 82 with respect to the case 74 and a male plug 84 is electrically coupled to the distal end 82 of the power cord 80. The male plug 84 is selectively plugged into a female electrical outlet to supply power to the case power supply 78. Additionally, a retractor 86 may be provided and the retractor 86 may be coupled to the case 74. The power cord 80 may be coupled to the retractor 86 such that the retractor 86 selectively and substantially retracts the power cord 80 into the case 74 for storage.

In use, each of the sets of wrenches 72 is placed in the case 74 to charge the at least one battery 66 corresponding to each of the wrenches 72. A selected one of the wrenches 72 is manipulated to tighten and looses the fastener 26. The first switch 60 is manipulated to actuate the clutch 52 to the transfer a selected amount of torque to the ring gear 38. The selected wrench 12 is manipulated to position the fastener 26 in the aperture 30 thereby facilitating the teeth 46 corresponding to the selected wrench 12 to engage the fastener 26. The second switch 62 is manipulated to turn on the motor 50 corresponding to the selected wrench 12. In this way the ring gear 38 corresponding to the selected wrench 12 is rotated to selectively loosen and tighten the fastener 26. Thus, the fastener 26 is selectively tightened and loosened without requiring the selected wrench 12 to be manually manipulated.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A powered wrench assembly being configured to selectively rotate a fastener, said assembly comprising:
a wrench being configured to be manipulated, said wrench having a first end, a second end, a top surface and a bottom surface, said first end having a slot extending toward said second end to define a pair of fingers being spaced apart from each other wherein each of said fingers is configured to grip a fastener thereby facilitating the fastener to be selectively tightened and loosened, said second end being rounded to define a lobe, said wrench having an aperture extending through said top surface and said bottom surface, said aperture being centrally positioned on said lobe having said aperture being concentric with said lobe wherein said aperture is configured to have the fasteners positioned therein, said aperture having a bounding surface, said wrench being substantially hollow between said first end and said second end to define a space within said wrench;
a rotating unit being movably coupled to said wrench wherein said rotating unit is configured to frictionally engage the fastener, said rotating unit being selectively turned on having said rotating unit rotating in said wrench wherein said rotating unit is configured to selectively tighten and loosen the fastener; and
a motor being positioned within said space in said wrench, said motor selectively rotating in a first direction and a second direction, said motor being engaged to said rotating unit to selectively rotate said rotating unit whereby said motor is configured to rotate the fastener.

2. (canceled)

3. (canceled)

4. The assembly according to claim 1, wherein
said wrench has an aperture extending therethrough, said aperture having a bounding surface; and
said rotating unit comprises a ring gear being rotatably positioned within said wrench, said ring gear having an inwardly facing surface, an outwardly facing surface and a top surface, said ring being positioned in said aperture having said inwardly facing surface being coextensive with said bounding surface.

5. The assembly according to claim 4, wherein said ring gear has a plurality of teeth, each of said teeth extending inwardly from said inwardly facing surface toward a center of said aperture, said teeth being spaced apart from each other and being distributed around said ring gear wherein each of said teeth is configured to frictionally engage the fastener when said second end of said wrench is positioned around the fastener, each of said teeth being comprised of a magnetic material wherein each of said teeth is configured to magnetically engage the fastener.

6. The assembly according to claim 4, further comprising a bearing being positioned within said second end of said wrench, said outwardly facing surface of said ring gear engaging said bearing such that said bearing reduces friction between said ring gear and said bearing.

7. (canceled)

8. (canceled) The assembly according to claim 1, further comprising:
a ring gear being rotatably coupled to said wrench; and
a clutch being positioned within said space in said wrench, said clutch being positioned between said motor and said ring gear, said clutch being mechanically coupled to said motor such that said motor rotates said clutch when said motor is turned on.

9. The assembly according to claim 8, further comprising a drive shaft being rotatably coupled to said clutch such that said clutch rotates said drive shaft when said motor is turned on, said drive shaft having a distal end with respect to said clutch.

10. The assembly according to claim 9, further comprising a drive gear being coupled to said distal end of said drive shaft such that said drive shaft rotates said drive gear when said motor is turned on, said drive gear engaging said top surface of said ring gear such that said drive gear rotates said ring gear when said motor is turned on.

11. The assembly according to claim 8, further comprising a first switch being slidably coupled to said wrench wherein said first switch is configured to be manipulated, said first switch being coupled to said clutch such that said first switch actuates said clutch between a minimum torque and a maximum torque wherein said clutch is configured to impart a selected amount of rotational torque to the fastener.

12. The assembly according to claim 8, further comprising a second switch being slidably coupled to said wrench wherein said second switch is configured to be manipulated, said second switch being electrically coupled to said motor, said second switch being selectively urged into a first position to turn said motor off, said second switch being selectively urged into a second position to turn said motor on to rotate in said first direction wherein said ring gear is configured to loosen the fastener, said second switch being selectively urged into a third position to turn said motor on to rotate in said second direction wherein said ring gear is configured to tighten the fastener.

13. The assembly according to claim 1, further comprising a power supply being positioned within said space in said wrench, said power supply being electrically coupled to said motor.

14. The assembly according to claim 13, wherein said power supply comprises at least one battery being positioned within said space, said at least one battery being electrically coupled to said motor.

15. The assembly according to claim 14, further comprising:
a plurality of first light emitters, each of said first light emitters being coupled to said top surface of said wrench wherein each of said first light emitters is configured to emit light outwardly therefrom, each of said first light emitters being electrically coupled to said at least one battery such that each of said first light emitters is sequentially turned on to indicate a charge level of said at least one battery, and
a charge port being coupled to said wrench wherein said charge port is configured to be electrically coupled to a power source, said charge port being electrically coupled to said at least one battery to charge said at least one battery.

16. A powered wrench assembly being configured to selectively rotate a fastener, said assembly comprising:
a wrench being configured to be manipulated, said wrench having a first end, a second end, a top surface and a bottom surface, said first end having a slot extending toward said second end to define a pair of fingers being spaced apart from each other wherein each of said fingers is configured to grip a fastener thereby facilitating the fastener to be selectively tightened and loosened, said second end being rounded to define a lobe, said wrench having an aperture extending through said top surface and said bottom surface, said aperture being centrally positioned on said lobe having said aperture being concentric with said lobe wherein said aperture is configured to have the fasteners positioned therein, said aperture having a bounding surface, said wrench being substantially hollow between said first end and said second end to define a space within said wrench; and
a rotating unit being movably coupled to said wrench wherein said rotating unit is configured to frictionally engage the fastener, said rotating unit being selectively turned on having said rotating unit rotating in said wrench wherein said rotating unit is configured to selectively tighten and loosen the fastener, said rotating unit comprising:
a ring gear being rotatably positioned within said wrench, said ring gear having an inwardly facing surface, an outwardly facing surface and a top surface, said ring being positioned in said aperture having said inwardly facing surface being coextensive with said bounding surface, said ring gear having a plurality of teeth, each of said teeth extending inwardly from said inwardly facing surface toward a center of said aperture, said teeth being spaced apart from each other and being distributed around said ring gear wherein each of said teeth is configured to frictionally engage the fastener when said second end of said wrench is positioned around the fastener, each of said teeth being comprised of a magnetic material wherein each of said teeth is configured to magnetically engage the fastener,
a bearing being positioned within said second end of said wrench, said outwardly facing surface of said ring gear engaging said bearing such that said bearing reduces friction between said ring gear and said bearing,
a motor being positioned within said space in said wrench, said motor selectively rotating in a first direction and a second direction, said motor being engaged to said ring gear to selectively rotate said ring gear whereby said motor is configured to rotate the fastener,
a clutch being positioned within said space in said wrench, said clutch being positioned between said motor and said ring gear, said clutch being mechanically coupled to said motor such that said motor rotates said clutch when said motor is turned on,
a drive shaft being rotatably coupled to said clutch such that said clutch rotates said drive shaft when said motor is turned on, said drive shaft having a distal end with respect to said clutch,
a drive gear being coupled to said distal end of said drive shaft such that said drive shaft rotates said drive gear when said motor is turned on, said drive gear engaging said top surface of said ring gear such that said drive gear rotates said ring gear when said motor is turned on,
a first switch being slidably coupled to said wrench wherein said first switch is configured to be manipulated, said first switch being coupled to said clutch such that said first switch actuates said clutch between a minimum torque and a maximum torque wherein said clutch is configured to impart a selected amount of rotational torque to the fastener,
a second switch being slidably coupled to said wrench wherein said second switch is configured to be manipulated, said second switch being electrically coupled to said motor, said second switch being selectively urged into a first position to turn said motor off, said second switch being selectively urged into a second position to turn said motor on to rotate in said first direction wherein said ring gear is configured to loosen the fastener, said second switch being selectively urged into a third position to turn said motor on to rotate in said second direction wherein said ring gear is configured to tighten the fastener, and
a power supply being positioned within said space in said wrench, said power supply being electrically coupled to said motor, said power supply comprising:
at least one battery being positioned within said space, said at least one battery being electrically coupled to said motor,
a plurality of first light emitters, each of said first light emitters being coupled to said top surface of said wrench wherein each of said first light emitters is configured to emit light outwardly therefrom, each of said first light emitters being electrically coupled to said at least one battery such that each of said first light emitters is sequentially turned on to indicate a charge level of said at least one battery, and
a charge port being coupled to said wrench wherein said charge port is configured to be electrically coupled to a power source, said charge port being electrically coupled to said at least one battery to charge said at least one battery.
